(19) United States
(12) Patent Application Publication
(10) Pub. No.: US 2023/0227983 A1
(43) Pub. Date: Jul. 20, 2023

(54) Process for Storing Energy as Compressed Gases in Subterranean Water Reservoirs Using High-Pressure Electrolysis

(71) Applicant: Robert Reynolds Tipton, Honolulu, HI (US)

(72) Inventor: Robert R. Tipton, Honolulu, HI (US)

(21) Appl. No.: 17/576,948

(22) Filed: Jan. 15, 2022

(51) Int. Cl. C25B 1/04; F28D 20/00

(52) U.S. Cl. CPC C25B 1/04; F28D 20/0052; F02C 3/22

(57) ABSTRACT

A process for storing large amounts of energy underground in existing or artificial aquifers at very large scale using deep-water, high-pressure electrolysis. The process is intended for use as large scale storage for electrical power grids. When implemented at depths greater than roughly 500 m, it provides stored energy density equal to or greater than lead-acid batteries while requiring only a pressure vessel. If the geologic structure is appropriate, the vessel may already exist naturally.

Because this process does not require compression of the gas(es), when the gas(es) is expanded it become quite cold and therefore extracts heat from the atmosphere. When combined with a sustainable energy source such as wind, solar, ocean or other similar source—the entire process is endothermic. The cold gas(es) can also be used to precipitate CO₂ and condense CH₄ directly from the atmosphere. This means the combination of these processes removes heat and carbon from the environment at the same time they provide large scale, lower cost grid energy storage.

This patent application is a refinement of provisional patent application #63/143,041 and inherits it's filing date. The refinement is to omit storing gases by compression. This was done because the inventor learned, since the provisional filing, that using direct compression is not a new innovation. The process of compressing atmosphere and storing it in subterranean aquifers was already developed by Hydrostor Canada. This application retains the innovation of using high-pressure electrolysis to generate the compressed gases, bypassing the compression step. The two processes were independent options of the provisional patent application and therefore eliminating gas compression does not violate the electrolysis option of the provisional patent.

The process described in this application stores energy in subterranean water reservoirs as compressed hydrogen or oxygen produced by high-pressure electrolysis. The compressed gas(es) may be used at a later time as an energy source thus storing energy.

The primary utilities of this process are:
This process provides low-cost, high-density energy storage and buffering for electrical distribution systems.
If the gas(es) produced by this process is expanded adiabatically, it becomes cold and under sufficient pressure liquefies. This very cold gas(es) may be used to drive endothermic heat engines.
This process produces hydrogen gas without a fossil fuel precursor such as methane.
This process does not require rare materials such lithium.
If the heat exchanger is properly designed, this process precipitates CO₂ and condenses CH₄ directly from the atmosphere providing inherent carbon capture.
Unlike current high pressure electrolysis systems, the source water is naturally pressurized by gravity instead of pumps.

This process requires:
A subterranean aquifer
A desalinizer if If the aquifer is saline
An electrolysis unit and electrical cable
A gas tight reservoir, either natural or artificial
A pipe(s) to deliver the gas(es) to the surface
A control system and appropriate valves to regulate the gas(es) flow
A heat exchanger
An endothermic engine may be used as option to extract more energy from the gas(es)
A hydrogen fueled power generator (such as a piston engine, turbine engine or fuel cell)
An optional condenser to recharge the aquifer with the water produced by burning the hydrogen, if desired

The steps in the process are:
1 Electricity flows through the cable from the surface to the electrolyzer
2 The electrolyzer splits the water into its component elements, H₂ and O₂
3 The hydrogen, and optionally the oxygen, are stored in reservoir(s)
4 When the gas(es) are required to provide power, the gas(es) in the reservoir(s) is released
   4.1 Using only a heat exchanger, the hydrogen is burned with either the stored or atmospheric oxygen to drive the generator
   4.2 Using an endothermic engine:
      4.2.1 The gas(es) are heated using a heat source such as the atmosphere and/or steam from the burning hydrogen
      4.2.2 Then the hydrogen is burned with either the stored oxygen or atmospheric oxygen to drive the generator
5 The generator, and optionally the endothermic engine, generates electricity
6 Atmosphere passed through the heat exchanger may optionally be fractionated into its constituent gases and those containing carbon can be stored for carbon capture.
7 The condensate from the cooling process may be used to recharge the aquifer.

It has been shown that it is possible to pump high pressure water into an existing subterranean reservoir, lifting the rock structure above it and using the elevated mass to store gravitational potential energy. While this method does store energy, doing so by raising the rock above the reservoir is far less efficient than storing the same energy as compressed gas. Using compressed gas can be done at constant pressure by displacing water as a closed system.

It is possible to use a subterranean reservoir of any depth, either a natural aquifer, artificial well or a depleted natural gas fracking site. Natural reservoirs range in depth from the surface to 9,000 m and also exist beneath the sea floor. A typical frack ing reservoir is 2,000 m to 6,000 m deep. Since each 10 m of depth produces approximately 1 atmosphere of compression, gas stored by this process could be compressed up to 900 times that of standard atmospheric pressure (900 bar.)

The gas is injected into the reservoir by high pressure electrolysis. One, or both, of the two product gases (H₂ and O₂) would be stored in the reservoir while unused gas would be released to the surface.

The high pressure gas(es) is released and may be used to drive expansion engines to run generators to produce electricity. The energy stored in the compressed gas(es) is expressed by the equation

E=VP₂ln (P₂/P₁) Eq 1

Where E is the energy stored, V is the volume of gas stored, P₂ is the storage pressure and P₁ is atmospheric pressure. Using typical depths of depleted fracking reservoirs E=94 to 330 KWH/cu m when stored as compressed gas and 1,100 to 3,400 KWH/cu m for compressed hydrogen. A typical domestic drilled water well with a depth of 250′ (75 m) would store 1.8 KWH/cu m of compressed gas or 42 KWH/cu m for compressed hydrogen.

The energy equation for the electrolysis of water is

Ee=286 KJ/mol Eq 2

While it is known that the energy required for electrolysis is independent of pressure (Eq 2), utilizing the natural water pressure at great depth and the resulting high pressure gas(es) as a working gas(es) was previously overlooked. This application of known natural phenomena for energy storage is a key innovation of this process.

The energy generated by burning 1 mol of hydrogen with ½ mol of oxygen to yield 1 mol of water is

Ec=257 KJ/mol Eq 3

Ec=0.0714 KWH/mol Eq 3a

1/Ec=14.0 mol/KWH Eq 3b

From Eq 2 and Eq 3, the amount of gasses produced per KWH can be derived

n=kₑE Eq 4

where

kₑ=1.5/Ec=1.5*14.0 mol/KWH Eq 5

The constant of 1.5 accounts for two gasses being produced, 1 mol of H₂ and ½ mol of O₂.

This formula for n can now be substituted into PV=nRT and solved for E/V to yield

PV=kₑERT Eq 6

and

Eₛₚ=E/V=Ec/Ee P/(k_{c}RT)=0.899P/(kₑRT) Eq 7

Where Eₛₚ is the specific energy due to combustion of the gasses.

Since the gas displaces water already in the reservoir, which can be kept at roughly equal head height in the source reservoir, the absolute pressure in the reservoir can be kept relatively constant. This reduces the water circulating in and out of the reservoir to 1.3% to 14% of that used by gravity potential energy storage. Since the pressure is constant, there will be little to no change in height of the rock structure and thus little to no risk of micro-quakes.

If storing the hydrogen gas only, the oxygen can be released into the atmosphere. When the stored hydrogen is released, not only can it be used to drive expansion motors and generators, but the gas can also be burned as fuel. The waste oxygen may be released through the expansion motors and generators to produce additional electricity which may be used to electrolyze more water. This increases the efficiency of the overall process.

If storing the oxygen gas, the hydrogen is used immediately, as above, to run the expansion generators, and burned as fuel, to electrolyze more water. While this method has lower stored energy density, no combustible gas is ever stored in the reservoir. While Hydrogen has less heat of combustion than natural gas (less explosive), the general public has a greater anxiety of being on top of a hydrogen reservoir and thus storing oxygen may be more readily accepted.

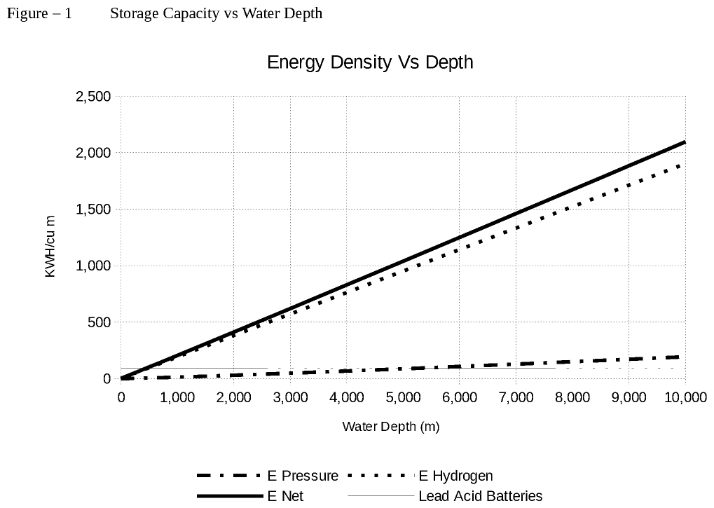

### FIG. 1 STORAGE CAPACITY VS WATER DEPTH

FIG. 1 shows a graph of energy density vs depth for gas pressure (Eq 1), hydrogen (Eq 7) and the two combined. The energy of a typical, lead acid battery is included for reference. This graph clearly shows the efficiency benefits of this process.

The primary benefits of this process are:
It has energy density as much as 20 times greater than lead-acid batteries.
The process requires no rare materials such as lithium.
It is sustainable.
If the endothermic engine and carbon capture options are used, this system extracts carbon from the atmosphere and is carbon negative.
It causes little to no displacement of the rock structure above the reservoir, resulting in little or no risk of damage to structures above the reservoir.
When compared with gravity storage, it requires greatly reduced volumes of water.
It has greatly reduced risk of subterranean water contamination.
There is no risk of toxic leakage as there is with many batteries.
Combined, these benefits make this one of the most effective methods for storing and buffering electrical energy.

Prior art and patents:
U.S. Pat. No. 8,261,552 Advanced adiabatic compressed air energy storage system
U.S. Pat. No. 4,808,029 System for subterranean storage of energy
U.S. Pat. No. 4,182,128 Underground pumped liquid energy storage system and method
U.S. Pat. No. 11,125,065 Hydraulic geofracture energy storage system with desalinization
U.S. Pat. No. 10,669,471 Hydraulic geofracture energy storage system with desalinization
U.S. Pat. No. 10,125,035 Hydraulic geofracture energy storage system with desalinization
U.S. Pat. No. 9,481,519 Hydraulic geofracture energy storage system with desalinization

The Canadian company Hydrostor is using methods similar to those described in U.S. Pat. No. 8,261,552. They are either licensing this patent or hold a similar foreign patent.

The US company Quidnet is currently developing the geofracture storage approach. Dark Sky Innovative Solutions review of geofracture storage has raised some concerns. In public briefings it's claimed the energy is stored by compression. Since both water and rock are deemed ‘in-compressible’ in engineering texts, it is highly unlikely that they can store significant energy. This is expressed by the formulae

E=½kx² Eq 8

and

F=kx Eq 9

These can be solved for E as a function of F and k as

E=½F²/k Eq 10

Equation 10 clearly shows that storing energy using force to compress a stiff material is very inefficient for energy storage. It is far more likely that the rock and water are lifted against gravity and act as a gravity battery.

In prior art, the working gas is taken from the atmosphere and pumped underground by force. The pumping step requires a great deal of energy and produces heat which must be recovered or released. This leads to the focus on an adiabatic (zero heat loss) process.

This process eliminates the compression step, replacing it with electrolysis of water into hydrogen and oxygen. This process stores much more energy per cubic meter, is endothermic and provides inherent carbon capture if desired.

These attributes make this process of far more commercial value and value to society and the welfare of the Earth's biosphere.

I, Robert R Tipton, declare that the material of this specification has not been changed.

I claim:

1. A process for electrolyzing water, under (or augmented by) the high ambient pressure present in deep water aquifers or wells, into highly pressurized hydrogen and oxygen

2. A process using the highly pressurized hydrogen and/or oxygen (claim 1) for energy storage.

3. A process which expands the high pressure gas(es) produced (and/or stored) by electrolysis of water at great depth under ground (claims 1 & 2) adiabatically to produce cold or liquid hydrogen and/or oxygen.

4. A process which uses a heat engine, the environment as the heat source and the cold gas(es) and/or liquid(s) produced by adiabatic expansion (claim 3) as the cold sink to produce electricity or mechanical work endothermically.
